(19) United States
(12) Patent Application Publication
(10) Pub. No.: US 2023/0208610 A1
(43) Pub. Date: Jun. 29, 2023

(54) EXECUTING AN ARITHMETIC CIRCUIT USING FULLY HOMOMORPHIC ENCRYPTION (FHE) AND MULTI-PARTY COMPUTATION (MPC)

(71) Applicant: International Business Machines Corporation, Armonk, NY (US)

(72) Inventors: Hayim Shaul, Kfar Saba (IL); OMRI SOCEANU, Haifa (IL); Ehud Aharoni, Kfar Saba (IL); Dov Murik, Haifa (IL); GILAD EZOV, Nesher (IL)

(21) Appl. No.: 17/646,157

(22) Filed: Dec. 28, 2021

(51) Int. Cl. H04L 9/00

(52) U.S. Cl. CPC H04L 9/008; H04L 2209/46; H04L 2209/122

(57) ABSTRACT

Executing the operations of an arithmetic circuit by using a hybrid strategy that employs both fully homomorphic encryption (FHE) methods and multi-party computation (MPC) methods. In order to utilize this hybrid strategy, an arithmetic circuit is split into multiple partitions (at least two), and each partition is assigned to be executed using FHE methods or MPC methods. Finally, this hybrid strategy is utilized in a manner that automatically takes into account CPU and network utilization costs.

### BACKGROUND

The present invention generally relates to the field of data encryption, and more specifically to the use of homomorphic data encryption for enterprise-related applications.

The Wikipedia entry for “Homomorphic encryption” (as of Nov. 8, 2021) states as follows: “Homomorphic encryption is a form of encryption that permits users to perform computations on its encrypted data without first decrypting it. These resulting computations are left in an encrypted form which, when decrypted, result in an identical output to that produced had the operations been performed on the unencrypted data. Homomorphic encryption can be used for privacy-preserving outsourced storage and computation. This allows data to be encrypted and outsourced to commercial cloud environments for processing, all while encrypted.”

### SUMMARY

According to an aspect of the present invention, there is a method, computer program product and/or system that performs the following operations (not necessarily in the following order): (i) receiving a set of fully homomorphic encryption (FHE) code, with the FHE code including instructions for generating an arithmetic circuit; (ii) creating, from the FHE code, an arithmetic circuit; (iii) partitioning the arithmetic circuit into multiple parts, with the partitioning being based, at least upon, CPU (central processing unit) and network parameters of a computer system; and (iv) responsive to the partitioning of the arithmetic circuit, executing a first partition each partition of the arithmetic circuit using FHE or multi-party computation (MPC) methods.

According to an aspect of the present invention, there is a method, computer program product and/or system that performs the following operations (not necessarily in the following order): (i) receiving a set of encrypted data, with the set of encrypted data including computer code from a first programming library, and with the computer code including instructions and data for designing an arithmetic circuit; (ii) replacing, through the use of a homomorphic encryption module, the computer code from the first programming library with computer code from a second programming library, with the second programming library being structured and configured to simulate the computer code from the first programming library; (iii) running the computer code with the second programming library to generate a log of operations performed during the run; (iv) responsive to the running of the computer code with the second programming library, formatting the log of operations to obtain a description of an arithmetic circuit; and (v) responsive to obtaining the description of the arithmetic circuit, partitioning the arithmetic circuits into a set of sub-circuits.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4A is a first directed acyclic graphical diagram showing an embodiment of the present invention; and

FIG. 4B is a second directed acyclic graphical diagram showing an embodiment of the present invention.

### DETAILED DESCRIPTION

Some embodiments of the present invention are directed towards executing the operations of an arithmetic circuit by using a hybrid strategy that employs both fully homomorphic encryption (FHE) methods and multi-party computation (MPC) methods. In order to utilize this hybrid strategy, an arithmetic circuit is split into multiple partitions (at least two), and each partition is assigned to be executed using FHE methods or MPC methods. Finally, this hybrid strategy is utilized in a manner that automatically takes into account CPU and network utilization costs.

Some embodiments of the present invention are additionally directed towards providing active methods to extract an arithmetic circuit that is described by programming code. Additionally, once the arithmetic circuit is extracted based upon the description in the programming code, there are methods that partition the arithmetic circuit into sub-circuits, with each sub-circuit being assigned to a different CPU (central processing unit) to execute the relevant functions of the sub-circuit.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

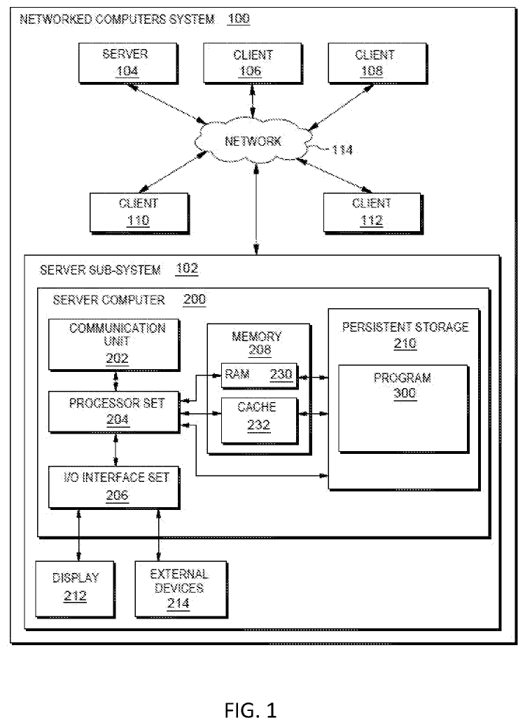

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

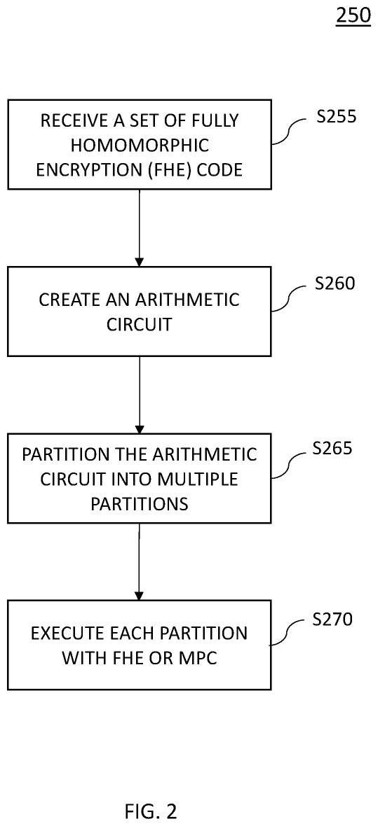

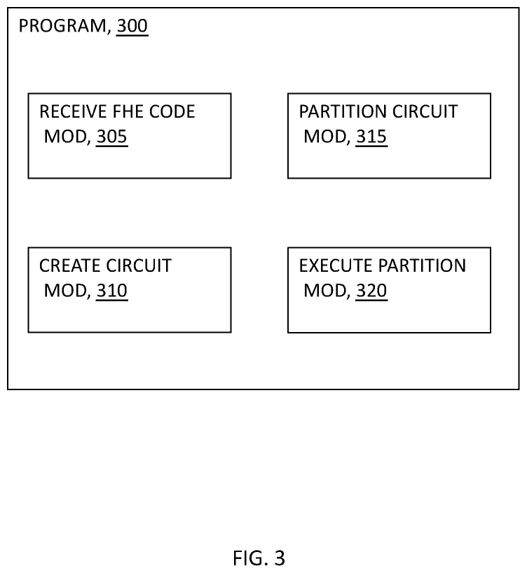

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where receive FHE code mod 305 receives a set of fully homomorphic encryption (FHE) code. In some embodiments of the present invention, this FHE code is configured with instructions and data that can generate an arithmetic circuit. In some embodiments of the present invention, the FHE code is initially run one time with a mock ciphertext. This mock ciphertext uses an arbitrary input to which the code is oblivious. This initial run of the FHE code with the mock ciphertext is ultimately used to create the arithmetic circuit.

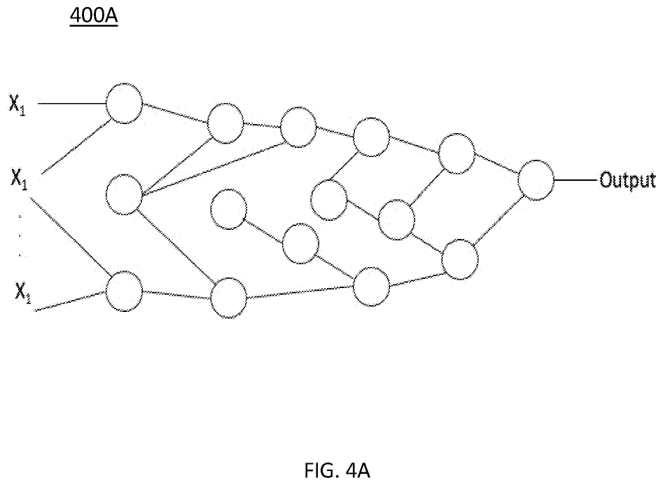

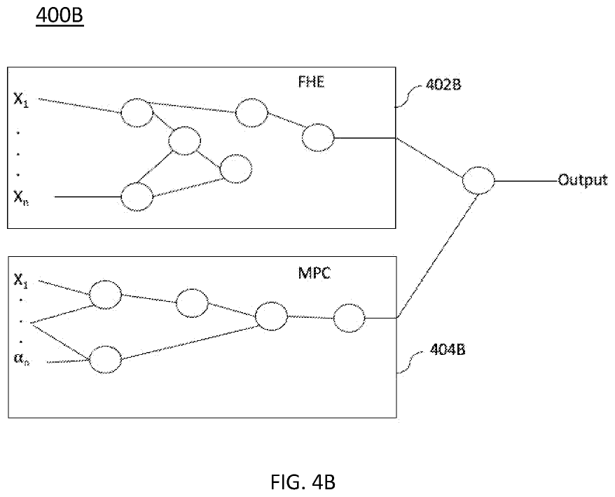

Processing proceeds to operation S260, where create circuit mod 310 uses the output of the initial run of the FHE code (discussed in connection with operation S255, above) to determine and record the operation that was performed. This action is used to create the arithmetic circuit. In some embodiments, the arithmetic circuit is represented graphically as a directed acyclic graph. An example of this type of arithmetic circuit is shown in diagram 400A of FIG. 4A.

Processing proceeds to operation S265, where partition circuit mod 315 creates multiple partitions of the arithmetic circuit (created in operation S260, above). In some embodiments of the present invention, the arithmetic circuit is partitioned based upon how efficiently each set of operations within the partition can be executed using either FHE or MPC methods. In essence, this efficiency can be measured by time, the overall cost savings to the CPU and network, and overall CPU and network utilization being minimized. An example of the arithmetic circuit being partitioned is shown in diagram 400B of FIG. 4B (with respect to partition 402B and partition 404B).

Processing finally proceeds to operation S270, where execute partition mod 320 executes each partition of the arithmetic circuit. In some embodiments, execute partition mod 320 can determine that a first partition (or first grouping of partitions) should be executed using FHE methods. In the same manner, execute partition mod 320 can determine that a second partition (or a second grouping of partitions) should be executed using MPC methods. In either case, execute partition mod 320 can make this decision based, at least in part, upon the overall CPU and/or network utilization costs being minimized.

### III. Further Comments and/or Embodiments

Recent advancements in cryptography demonstrates how several parties can collaborate and compute a function on their secret inputs without disclosing their inputs. Specifically, cryptographers showed encryption schemes where arithmetic operations (such as addition and multiplication) can be applied on ciphertexts, typically referred to as homomorphic encryption (HE). The inputs of such an operation can be either a ciphertext encrypting an input value or a ciphertext which is the output of another operations. Since it can take a long period of time to run operations on ciphertexts, various solutions utilize several CPUs (central processing units) to achieve better running times.

However, there are very few libraries that implement HE operations. The overwhelming majority of these libraries are written in C++, while developers use different programming languages depending on the given task. A popular programming language is Python. The use of Python increases the research and development time because many algorithms are first written in Python during the research stage and then migrated to C++ to be implemented with HE.

Currently, there are no successful solutions to migrate from one higher-level language to another. Embodiments of the present invention describe how homomorphic encryption code can be written in one language and then be migrated to be executed in a different language.

Implementation of Privacy Preserving Operations:

Embodiments of the present invention are relevant to all privacy preserving technologies, such as homomorphic encryption, MPC with Beaver Triples and garbled circuits. Specifically, for HE, there are several software libraries implementing homomorphic encryption and their respective privacy preserving arithmetic operations (such as HElib, Seal, Palisade, TFHE, etc.).

Previous Work and Reasons why Implementation can be Difficult:

The main challenge is analyzing code written by human developers, and specifically understanding the code and converting it to a circuit. To make this challenge even more difficult, the code written by developers is sequential in nature while a circuit is parallel in nature.

The problem of writing an automatic tool that reads a computer program and outputs the underlying circuit is a difficult one. In hardware design, there is a similar problem of converting code (software) into a Boolean circuit. To date, there is no solution that achieves that result although there have been many years of research spent on solving this problem.

In an arithmetic circuit, there has been an attempt to extract the underlying circuit and apply optimizations on the extracted circuit. In one study, the authors propose an environment (RAMPARTS) where a programmer needs to use a programming language called Julia, which is then analyzed to understand the underlying circuit and suggest optimizations. This does not solve the problem in any way because it restricts the researcher to work with a very specific programming environment.

In another study, the authors propose a new programing language for HE which includes an optimizer. This also does not solve the problem in any way because it also restricts the researcher to work with a very specific programming environment.

Embodiments of the present invention provide a method to extract the circuit described by the code by employing an active analysis rather than the prevalent passive analysis. Embodiments of the present invention run the code over encrypted data, generating a log of all operations performed during a run of a privacy preserving library, and converting the logs into a description of a circuit (for example, in a NetList format). After the conversion, embodiments of the present invention partition the circuit to independent sub-circuits for added parallelization benefits. In addition, the circuit can be converted back to code of a different library in order to test for performance improvements.

Previous attempts to extract the arithmetic circuit were unsuccessful or incomplete. In some studies, the authors describe a passive extracting method that does not extract the entire circuit. Also, the systems these studies describe restrict the researcher to use a specific programming environment. Because this passive extracting method yielded an incomplete circuit, it could not address the problem of executing the circuit with a different language.

Some embodiments of the present invention include active methods to extract the arithmetic circuit a code describes. This is different than other solutions that use only passive methods. In another embodiment of the present invention, once the description of the arithmetic circuit is obtained, some embodiments of the present invention partition the circuit into sub-circuits and assign each sub-circuit to be executed by a different CPU.

Specifically, two observations can be made:

(1) Active vs. Passive analysis: When embodiments of the present invention extract the circuit from a code, this is considered to be active and not passive. This means that in addition to passively analyzing the code, this code can be run and its progress can be logged while the code is being run.

(2) Oblivious to data: The code and arithmetic circuit are oblivious to the input. Specifically the code and the circuit are run in the same way regardless of what the input is.

Putting these two observations together, embodiments of the present invention can perform the following steps to extract the circuit described by code:

(i) Use a programming language of the researcher's choice and replace the privacy preserving library with a library that has the same interface. In this instance, the code does not need to be changed. The new library can simulate the operation of the original library. In addition, the new library will create a log for each operation it performs (including the operation type and its inputs);

(ii) Run the code with the replaced library to generate a log of all operations performed during a given run. Because the code is oblivious to the input, the same operations will be performed on every input; and

(iii) Format the logs generated at step (ii) as a description of a circuit. Each log entry from step (ii) includes the gate type, the input wire labels, and the output wire label.

After having created a circuit description, one or more of these steps can be taken: (i) execute the extracted circuit with a generic program written in C++ that executes circuits; and/or (ii) input to the system.

The input to the system is a code written by a developer in some higher language such as C++. For example, computing the product of variables a, b, c, and d may be as shown below:

ab=mul(a,b)

cd=mul(c,d)

x=mul(ab,cd).

In the first line, the code computes the product of the variables a and b, and stores it in the variable ab. In the second line, the code computes the product of the variables c and d, and stores it in the variable cd. Finally, the code computes the product of the variables ab and cd to get the product of a, b, c, and d.

The output of the system is a written description of an arithmetic circuit. For example, these outputs are shown as follows: (i) “Multiplication gate with the inputs a and b, and the output called ab;” (ii) “Multiplication gate with the inputs c and d, and the output called cd;” and/or (iii) “Multiplication gate with the inputs ab and cd, and the output called x.”

Some embodiments of the present invention run an arithmetic circuit in a different programming language. Using a language with a library implementing FHE operations, embodiments of the present invention can write a generic code that executes arithmetic circuits. This code can then be used to execute the circuit extracted in the previous step.

In some embodiments, an arithmetic circuit (AC) can be executed by iteratively picking a gate whose inputs are ready and computing its input. To execute an AC with multiple threads, each thread can pick a gate to execute where the only restriction is that the inputs of the gates are ready. In the multi-threaded case, passing ciphertexts from one gate to another is easy because all the threads share the same memory space.

In a multi-server case, threads running on different servers do not share the same memory space. In this case, if a ciphertext was computed by a gate on one server and is needed as an input to a gate on a second server, it needs to be transmitted over a communication channel which is usually much slower than memory. In this instance, embodiments of the present invention minimize the number of ciphertexts transmitted between the servers while still utilizing their processing power.

Embodiments of the present invention provide a few heuristics that start with an input circuit and modify it to an equivalent circuit. The equivalent circuit is partitioned such that executing each part on a different server requires the transfer of only a small number of ciphertexts.

To simplify the description, embodiments of the present invention assume that all servers have access to all inputs to the AC. This is a reasonable assumption for computation delegation scenario where a user uploads his or her data to the cloud to perform some computation. In this case, the data can be broadcast to all servers of the cloud. In a more general multi-party computation (MPC), where each party has its own data, the methods below can be extended appropriately.

Polynomial Approach:

With respect to polynomial approach, the polynomial is described by a circuit and a few heuristics to find better polynomial representations that induce circuits that easily partitioned are considered.

In this case, an n-variate polynomial of degree d can be written as P^{(d,n)}(x₁, x₂, . . . xₙ). The degree of P can be denoted as Deg(P). Additionally, the degree d can be defined as d=Deg(P^{(d,n)}), and the size of the number of polynomials P can be denoted as Size(P). Given a polynomial P_{d,n}(x̅), embodiments of the present invention will find polynomials Q₁, Q₂, . . . Qᵣ and R₁, R₂, . . . Rᵣ, for some r>1 such that P=ΣᵢQᵢRᵢ. Ideally, r is small and Deg(Qᵢ)=Deg(Rᵢ), for i=1, 2, . . . r.

Given this decomposition of P, one server can compute Qᵢ(x), for i=1, 2, . . . r, and the second server can compute Rᵢ(x), for i=1, 2, . . . r. In this case, P can be computed by transmitting r ciphertexts: cᵢ=Rᵢ(x), for i=1, 2, . . . r from server two (2) to server one (1) computing ΣQᵢ(x)cᵢ to complete the computation of P.

Univariate Case:

The univariate case describes a simple heuristic for the case where P is a univariate (that is, P can be represented as P^{(d,1)}). In this case, divide P^{(d,1)} by a random (d/2)-degree polynomial Q₁^{(d/2,1)}(x) to get P^{(d,1)}=Q₁^{(d/2,1)}R₁^{(d/2,1)}+S₁^{(d/2,1)}, where S^{(d/2,1)} is the remainder. This process continues recursively on S₁^{(d/2,1)} to get the following decomposition: P^{(d,1)}=Q₁^{(d/2,1)}R₁^{(d/2,1)}+Q₁^{(d/4,1)}R₁^{(d/4,1)}+ . . . . In this instance, r=log_{d}.

Decomposition by Factorization:

In certain references, algorithms for the factorization of multivariate polynomials were given. A factorization of a polynomial admits the following trivial decomposition: P(x)=Q(x)R(x), where Q and R are products of polynomial factors.

Heuristics of Embodiments of the Present Invention:

A heuristic using dynamic programming to find a decomposition of a polynomial P is presented as follows. First, it can be established that there are

$$\frac{n + d - 1}{n - 1}$$

different monomials of degree d with n variables. Therefore, a degree-d n-variate polynomials has

$${\sum }_{d} ( \begin{matrix}n + d - 1 \\ n - 1\end{matrix} ) = \frac{n + d}{n}$$

monomials. This means that a polynomial P^{(d,n)} has

$$( \begin{matrix}n + d \\ n\end{matrix} )$$

coefficients, each tor a different monomial.

Consider the following: let P^{(d,n)}, Q^{(d/2,n)}, R^{(d/2,n)}, T^{(d/2,n)} be polynomials such that P(x)=Q(x)R(x)+S(x). An equation system can be set up so that Q, R, and S are variables and each coefficient of P admits an equation. For sufficiently large values of d and n, it holds that

$$( \begin{matrix}n + d \\ n\end{matrix} ) > 3 ( \begin{matrix}n + d / 2 \\ n\end{matrix} )$$

and therefore there are many solutions for Q(x), R(x), and S(x). Ideally, embodiments of the present invention want to find a solution with few monomials (that is, those with a coefficient value of zero (0)). This can be done by iterative solutions such as Newton-Raphson for high dimensions.

Circuit Approach:

The circuit approach considers the arithmetic circuit and shows a few heuristics to partition it, and is complementary to the polynomial approach (discussed above). With respect to the polynomial approach, embodiments of the present invention considered how a circuit can be modified to a different circuit that realizes an equivalent polynomial. With respect to the circuit approach, embodiments of the present invention consider the problem of how the gates of a given circuit can be partitioned between multiple servers to improve the overall running time.

Gradient Descent Algorithm:

The first heuristic, if formulated correctly, is a variant of a gradient descent algorithm. In this heuristic, some embodiments start with a given partition where each gate is assigned to be executed on one of the servers. Then, some embodiments repeatedly apply a step in which to look for a local change to the assignment of gates to servers. The algorithm ends when a local change that improves the running time of the circuit cannot be found. Since some embodiments apply a change only if it improves the running time of the circuit, it is guaranteed that the algorithm terminates.

This algorithm can be thought of as a “gradient descent” algorithm. An objective function ƒ:{S}^{q}→R, where S is the number of servers and g is the number of gates. A point in this space is a partition of g gates to S servers. In each iteration of the algorithm, embodiments take a step along the steepest gradient from a small subset of gradients that are considered. This algorithm can be described in the following manner:

(1) Input: A circuit C with g gates, a number S > 1 of servers to run C on
(2) Output: A vector p ϵ {1, . . . , S}^{g} assigning each gate to a server
(3) p := the initial vector in {1, . . . , S}^{g} // see more below
(4) Descent step: //find best gradient
(5) K := neighbors of p // See more below
(6) k := argmin_{kϵK}^{Time(k)} // If taking the next step has better times then take it
(7) if Time(k) < Time(p) then
(8) p := k
(9) Go to Line (4)
(10) End

This algorithm describes a variant of the gradient descent approach. This approach considers the objective function of time as Time: {1, . . . , S}^{g}→R, which takes as an input an assignment of g gates to one of S servers and outputs the time this assignment will take to compute. In line (3), the algorithm starts from an initial starting point. This can be an assignment where all gates are assigned to a single server or a random assignment or any other assignment. The initial assignment is set into a variable p, which holds, throughout the algorithm, the best assignment found so far.

This algorithm executes the gradient-descent step in Lines 4-9. In these lines, the algorithm tries to find an assignment that is better than p. If such as assignment is found, then p is replaced with the better assignment and the algorithm repeats another iteration of the gradient descent. Typically, in a gradient descent approach, the algorithm considers only a small subset of candidates from the entire space and typically these candidates are close to p (i.e. neighbors) by some metric.

In Line (5), the algorithm considers all the neighbors of p. In the context of assignments of g gates to S servers, that can be for example all assignments that are different from p in n≥1 gates, where n is a parameter. For example, if n=6, the algorithm will consider all assignments that agree with p on g−6 gates. In Line (6), the algorithm calculates the time to compute the circuit for each assignment in the subset K and sets k to be the assignment with the minimal time. Then, if k has better times than p, the algorithm changes p to be k (as shown in Line 8) and repeats the gradient descent step.

Some embodiments of the present invention recognize the following facts, potential problems and/or potential areas for improvement with respect to the current state of the art: (i) homomorphic encryption (HE) is slow, but is communication efficient; (ii) multi-party computation (MPC) is fast but communication inefficient; and (iii) switching between these two methods is difficult because it is time consuming, expensive, error prone, and needs to be re-done for each deployment of a given project.

Embodiments of the present invention provide efficient solutions to switch between HE and MPC methods in order to efficiently calculate outputs of a given arithmetic circuit. In addition, embodiments of the present invention are designed to improve any modules that require and/or otherwise utilize privacy preserving computation between two (2) parties.

Embodiments of the present invention automatically partition code into multiple parts and executes each part using FHE methods of MPC methods. A method according to some embodiments of the present invention include the following operations (not necessarily in the following order): (i) start with fully homomorphic encryption (FHE) code; (ii) run the FHE code once with a mock ciphertext, with this first run including an arbitrary input for which the FHE code is oblivious; (iii) record the operation that is performed—this action forms an arithmetic circuit (also sometimes referred to and represented as an acyclic directed graph); (iv) partition the arithmetic circuit into multiple parts (to balance the CPU and network parameters for computing the circuit); and (v) execute each part with either FHE or MPC.

Previously, several programs exist that process operations using FHE code, including programs that convert C++ code into FHE code, creates a language and compilers for efficient HE computation, and converting C++ code into a Boolean circuit and optimizes the solution for the circuit. However, none of these programs address the problem of combining or transferring FHE code protocol with MPC protocol. Embodiments of the present invention addresses this problem by automatically accounting for CPU and/or network costs when executing FHE and/or MPC based systems.

A method according to some embodiments of the present invention include the following operations (not necessarily in the following order): (i) receive an underlying arithmetic circuit (see diagram 400A of FIG. 4A) and run the circuit with a mockup class that keeps track of each operation; (ii) partition the circuit into at least two parts that account for at least one FHE partition and at least one MPC partition (see diagram 400B of FIG. 4B); (iii) repeatedly swap two gates to change the CPU and network loads until a desired CPU/network utilization goal is reached; and (iv) run the circuit on with MPC, and iteratively execute each gate in the circuit using MPC.

Some embodiments of the present invention include the following features, characteristics and/or advantages: (i) deals with a useful technology that can improve CPU and network utilization balance of privacy preserving applications; (ii) automatically generate a hybrid FHE-MPC solution to improve resource utilization; (iii) reduces the development and deployment of any project and product that uses FHE or MPC, thereby potentially saving time with respect to development and deployment and saving costs; and (iv) improves run times and network utilization in privacy preserving products.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a set of fully homomorphic encryption (FHE) code including instructions for generating an arithmetic circuit;
creating, from the set of FHE code, the arithmetic circuit;
partitioning the arithmetic circuit into multiple partitions, the partitioning based, at least in part, on central processing unit (CPU) and network parameters of a computer system; and
responsive to the partitioning of the arithmetic circuit, determining to execute each partition of the arithmetic circuit using one of an FHE method or a multi-party computation (MPC) method.

2. The CIM of claim 1 wherein:
the multiple partitions includes at least a first partition and a second partition; and
further comprising:
executing the first partition using the FHE method based, at least in part, upon a resulting CPU or network cost; and
executing the second partition using the MPC method based, at least in part, upon a resulting CPU or network cost.

3. The CIM of claim 2 wherein the executing of the first partition using the FHE method and executing the second partition using the MPC method improves an overall resource utilization value of a CPU and/or network with respect to a baseline resource utilization value.

4. The CIM of claim 1 wherein determining to execute each partition of the arithmetic circuit using one of an FHE method or an MPC method reduces the overall runtime for a given application with respect to earlier-recorded runtimes of the given application.

5. The CIM of claim 1 wherein determining to execute each partition of the arithmetic circuit using one of an FHE method or an MPC method reduces computational errors compared to executing each partition with only an FHE method.

6. A computer program product (CPP) comprising a computer-readable storage medium having a set of instructions stored therein which, when executed by a processor, causes the processor to perform a method comprising:
receiving a set of fully homomorphic encryption (FHE) code including instructions for generating an arithmetic circuit;
creating, from the set of FHE code, the arithmetic circuit;
partitioning the arithmetic circuit into multiple partitions, the partitioning based, at least in part, on central processing unit (CPU) and network parameters of a computer system; and
responsive to the partitioning of the arithmetic circuit, determining to execute each partition of the arithmetic circuit using one of an FHE method or a multi-party computation (MPC) method.

7. The CPP of claim 6 wherein:
the multiple partitions includes at least a first partition and a second partition; and
further comprising:
executing the first partition using the FHE method based, at least in part, upon a resulting CPU or network cost; and
executing the second partition using the MPC method based, at least in part, upon a resulting CPU or network cost.

8. The CPP of claim 7 wherein the executing of the first partition using the FHE method and executing the second partition using the MPC method improves an overall resource utilization value of a CPU and/or network with respect to a baseline resource utilization value.

9. The CPP of claim 6 wherein determining to execute each partition of the arithmetic circuit using one of an FHE method or an MPC method reduces the overall runtime for a given application with respect to earlier-recorded runtimes of the given application.

10. The CPP of claim 6 wherein determining to execute each partition of the arithmetic circuit using one of an FHE method or an MPC method reduces computational errors compared to executing each partition with only an FHE method.

11. A computer system (CS) comprising:
a processor(s) set;
a machine readable storage device; and
computer code stored on the machine readable storage device, with the computer code including instructions and data for causing a processor(s) set to perform operations including the following:
receiving a set of fully homomorphic encryption (FHE) code including instructions for generating an arithmetic circuit;
creating, from the set of FHE code, the arithmetic circuit;
partitioning the arithmetic circuit into multiple partitions, the partitioning based, at least in part, on central processing unit (CPU) and network parameters of a computer system; and
responsive to the partitioning of the arithmetic circuit, determining to execute each partition of the arithmetic circuit using one of an FHE method or a multi-party computation (MPC) method.

12. The CS of claim 11 wherein:
the multiple partitions includes at least a first partition and a second partition; and
further comprising:
executing the first partition using the FHE method based, at least in part, upon a resulting CPU or network cost; and
executing the second partition using the MPC method based, at least in part, upon a resulting CPU or network cost.

13. The CS of claim 12 wherein the executing of the first partition using the FHE method and executing the second partition using the MPC method improves an overall resource utilization value of a CPU and/or network with respect to a baseline resource utilization value.

14. The CS of claim 11 wherein determining to execute each partition of the arithmetic circuit using one of an FHE method or an MPC method reduces the overall runtime for a given application with respect to earlier-recorded runtimes of the given application.

15. The CS of claim 11 wherein determining to execute each partition of the arithmetic circuit using one of an FHE method or an MPC method reduces computational errors compared to executing each partition with only an FHE method.
